(19) United States
(12) Patent Application Publication
(10) Pub. No.: US 2015/0120208 A1
(43) Pub. Date: Apr. 30, 2015

(54) SYSTEM AND METHOD FOR ALIGNING GENOME SEQUENCE IN CONSIDERATION OF ACCURACY

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 14/529,688

(22) Filed: Oct. 31, 2014

(30) Foreign Application Priority Data
Oct. 31, 2013 (KR) 10-2013-0130679

(51) Int. Cl. G06F 19/22

(52) U.S. Cl. CPC G06F 19/22
USPC 702/19

(57) ABSTRACT

There are provided a sequence aligning device in consideration of accuracy, and a method thereof. The sequence aligning apparatus of an embodiment of the present disclosure includes a seed extracting unit configured to extract at least one seed that is exactly matched to a reference sequence from a read; a mapping score calculating unit configured to, with respect to each of the at least one extracted seed, map a left area and a right area of the read to the reference sequence based on the seed at each mapping position of the reference sequence of each seed, and calculate a left mapping score and a right mapping score of each mapping position from the mapping result; and a read aligning unit configured to determine a mapping position in each reference sequence of the at least one seed using the calculated left mapping score and right mapping score.

### CROSS-REFERENCE TO RELATED APPLICATION

This application claims priority to and the benefit of Korean Patent Application No. 10-2013-0130679, filed on Oct. 31, 2013, the disclosure of which is incorporated herein by reference in its entirety.

### BACKGROUND

1. Field

Embodiments of the present disclosure relate to technology for analyzing a genome sequence.

2. Discussion of Related Art

In general, when sequence alignment between a reference sequence and a read is performed, exact matching based on homology of a sequence is used. However, due to errors in a sequencing operation, polymorphism of genetic information of organisms, and the like, a sequence alignment algorithm needs to allow a certain degree of errors (mismatch).

In particular, the sequence alignment algorithm allowing a certain degree of errors in this manner may be effective in research on an entire genome of a specific organism and the like. However, in medical markets for diagnosing only a specific disease, for example, cancer, there are many cases in which only some regions related to the specific disease are analyzed rather than analyzing the entire genome. In this case, in a sequence alignment algorithm, high accuracy is more important than a high speed.

### SUMMARY

Embodiments of the present disclosure provide a sequence aligning method for more accurately aligning a large amount of short sequences (reads) obtained from a sequencer.

According to an aspect of the present disclosure, there is provided a sequence aligning apparatus including a seed extracting unit configured to extract a seed that is matched to a reference sequence from a read; a mapping score calculating unit configured to, with respect to the seed, map a first area to a left of the seed of the read and a second area to a right of the seed of the read, and calculate a left mapping score and a right mapping score based on the first and the second areas, respectively; and a read aligning unit configured to determine a mapping position in the reference sequence of the read using the left mapping score and the right mapping score.

The mapping score calculating unit sequentially may map the first area of the read to the reference sequence in a left direction from a base connected to the seed at the first area of the read, and sequentially maps the second area of the read to the reference sequence in a right direction from a base connected to the seed at the second area of the read.

The mapping score calculating unit may generate a first matrix in which the left area of the read and a first part of the reference sequence corresponding to the first area are assigned to columns and rows, and a second matrix in which the second area of the read and a second part of the reference sequence corresponding to the second area are assigned to a second set of columns and rows, assign a match score or a mismatch score, which is set according to whether a corresponding row value and a corresponding column value of a corresponding cell match, to each corresponding cell of the first matrix and the second matrix, and calculate the left mapping score and the right mapping score using the first matrix and the second matrix to which match scores and mismatch scores are assigned.

The left mapping score may be a greatest value of a sum of the match scores and the mismatch scores assigned along a path formed by starting from a top-rightmost cell of the first matrix, sequentially moving in any direction of left, down, or diagonally downward to the left direction, and reaching a bottom-leftmost cell of the first matrix, and the right mapping score may be a greatest value of a sum of the match scores and the mismatch scores assigned along a path formed by starting from a top-leftmost cell of the second matrix, sequentially moving in any direction of a right, bottom, or diagonally downward to the right direction, and reaching a bottom-rightmost cell of the second matrix.

The match scores may be real numbers of 0 or greater, and the mismatch scores may be real numbers less than 0.

The match scores may be set to 1, and the mismatch scores may be set to −1.

The read aligning unit may determine a mapping position having the greatest value of the sum as the mapping position of the read, among mapping positions having sums of the left mapping scores and the sums of the right mapping scores calculated for the mapping position in the reference sequence of the seed that is greater than a set reference value.

According to another aspect of the present disclosure, there is provided a sequence aligning method including extracting, by a seed extracting unit, a seed that is matched to a reference sequence from a read; mapping, by a mapping score calculating unit, with respect to the seed, a first area to a left of the seed of the read and a second area to a right of the seed of the read, and calculating a left mapping score and a right mapping score based on the first and the second areas, respectively; and determining, by a read aligning unit, a mapping position in the reference sequence of the read using the left mapping score and the right mapping score.

The calculating of the left mapping score and the right mapping score may include sequentially mapping the first area to the reference sequence in a left direction from a base connected to the seed at the first area of the read, and sequentially mapping the second area to the reference sequence in a right direction from a base connected to the seed at the second area of the read.

The calculating of the left mapping score and the right mapping score may further include generating a first matrix in which the first area of the read and a first part of the reference sequence corresponding to the first area are assigned to a first set of columns and rows, and a second matrix in which the second area of the read and a second part of the reference sequence corresponding to the second area are assigned to a second set of columns and rows, assigning a match score or a mismatch score, which is set according to whether corresponding a row value and a corresponding column value of a corresponding cell match, to each corresponding cell of the first matrix and the second matrix, and calculating the left mapping score and the right mapping score using the first matrix and the second matrix to which match scores and the mismatch scores are assigned.

The left mapping score may be a greatest value of a sum of the match scores and the mismatch scores assigned along a path formed by starting from a top-rightmost cell of the first matrix, sequentially moving in any direction of left, down, or diagonally downward to the left direction, and reaching a bottom-leftmost cell of the first matrix, and the right mapping score may be a greatest value of a sum of the match scores and the mismatch scores assigned along a path formed by starting from the top-leftmost cell of the second matrix, sequentially moving in any direction of a right, bottom, or diagonally downward to the right direction, and reaching the bottom-rightmost cell of the second matrix.

The match scores may be real numbers of 0 or greater, and the mismatch scores may be real numbers less than 0.

The match scores may be set to 1, and the mismatch scores may be set to −1.

The determining of the mapping position may include determining a mapping position having the greatest value of the sum as the mapping position of the read, among mapping positions having sums of the left mapping scores and the sums of the right mapping scores calculated for the mapping position in the reference sequence of the seed that is greater than a set reference value.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a sequence aligning apparatus 100 according to an embodiment of the present disclosure;

FIG. 2 is an exemplary diagram illustrating division of a read based on a seed according to an embodiment of the present disclosure;

FIG. 3 is an exemplary diagram illustrating mapping start points of a left area and a right area of a read and a mapping direction according to an embodiment of the present disclosure;

FIG. 4 is a diagram illustrating an exemplary operation of generating a first matrix and a second matrix;

FIG. 5 is a diagram illustrating an exemplary operation of a read aligning unit 106 determining an alignment position of a read using a mapping score according to an embodiment of the present disclosure; and

FIG. 6 is a flowchart illustrating a sequence aligning method 600 according to an embodiment of the present disclosure the.

### DETAILED DESCRIPTION OF EXEMPLARY EMBODIMENTS

Hereinafter, detailed embodiments of the present disclosure will be described with reference to the drawings. The following detailed description is provided to help comprehensive understanding of methods, devices and/or systems described in this specification. However, these are only examples, and the present disclosure is not limited thereto.

In descriptions of the present disclosure, when it is determined that detailed descriptions of related well-known functions unnecessarily obscure the gist of the present disclosure, detailed descriptions thereof will be omitted. Some terms described below are defined by considering functions in the present disclosure, and meanings may vary depending on, for example, a user or operator's intentions or customs. Therefore, the meanings of terms should be interpreted based on the scope throughout this specification. The terminology used in detailed description is provided to only describe embodiments of the present disclosure and not for purposes of limitation. Unless the context clearly indicates otherwise, the singular forms include the plural forms. It will be understood that the terms “comprises” or “includes” when used herein, specify some features, numbers, steps, operations, elements, and/or combinations thereof, but do not preclude the presence or possibility of one or more other features, numbers, steps, operations, elements, and/or combinations thereof in addition to the description.

Before detailed descriptions of embodiments of the present disclosure, first, the terms used herein will be described. First, the term “read” is sequence data having a short length output from a genome sequencer. In general, the read has different lengths ranging from about 35 to 500 base pair (bp) according to a type of the sequencer. In general, a DNA base is represented as alphabet letters, A, C, G, and T.

The term “reference sequence” refers to a sequence that is referred to when an entire sequence is generated from the reads. In sequence analysis, a large amount of reads output from the genome sequencer are mapped with reference to the reference sequence, thereby completing the entire sequence. In the present disclosure, the reference sequence may be a predetermined sequence (for example, the entire human sequence) in sequence analysis, or a sequence made in the genome sequencer may also be used as the reference sequence.

The term “base” is a minimum unit of the reference sequence and the read. As described above, the DNA base may include four alphabet letters, A, C, G, and T, each letter is represented as a base. That is, the DNA bases are represented by four bases and this is the same as in the read.

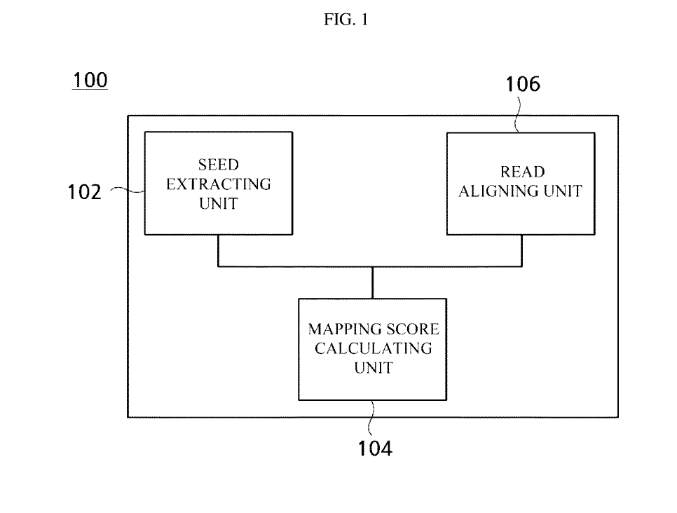

FIG. 1 is a block diagram illustrating a sequence aligning apparatus 100 according to an embodiment of the present disclosure. As illustrated, the sequence aligning apparatus 100 according to the embodiment of the present disclosure includes a seed extracting unit 102, a mapping score calculating unit 104, and a read aligning unit 106.

The seed extracting unit 102 extracts at least one seed from the read output from the genome sequencer. In the embodiment of the present disclosure, the seed is a sequence serving as a unit when the read and the reference sequence are compared for mapping of the read. In an embodiment, the seed extracting unit 102 generates at least one fragment from the read and may select fragments that are exactly matched to the reference sequence among the fragments as the seed serving as a basic unit of mapping. That is, in the embodiments of the present disclosure, the seed refers to a fragment that is exactly matched to the reference sequence among fragments generated from the read. In this case, since a method of generating fragments from the read is not specifically limited, the seed extracting unit 102 may generate fragments from the read using various methods.

With respect to each of the at least one extracted seed, the mapping score calculating unit 104 maps a left area and a right area of the read to the reference sequence based on the seed at each mapping position of the reference sequence of each seed. Also, the mapping score calculating unit 104 calculates a left mapping score and a right mapping score of each mapping position from the mapping result.

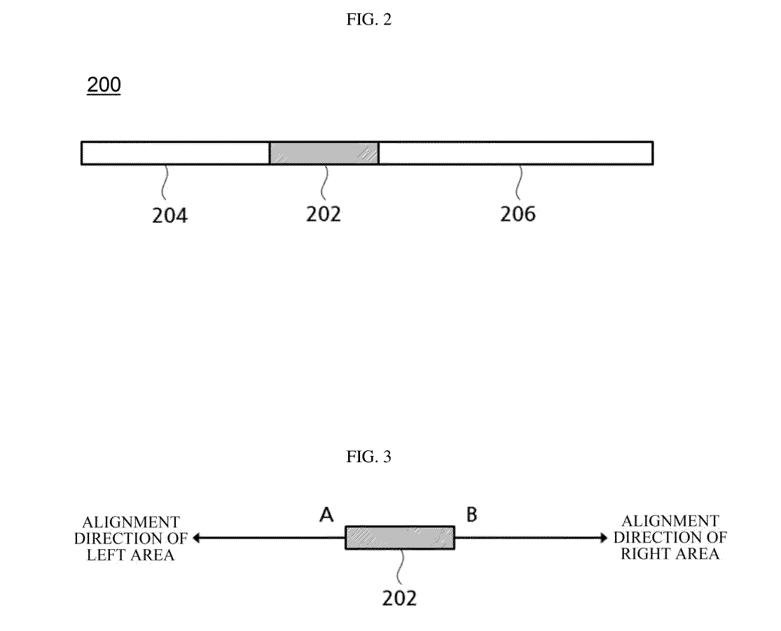

An operation of calculating the left mapping score and the right mapping score in the mapping score calculating unit 104 will be described in greater detail below. First, the mapping score calculating unit 104 selects a seed among seeds generated in the seed extracting unit 102. In this case, the read is divided into two areas, left and right areas, based on the selected seed. FIG. 2 shows this operation. That is, as illustrated, a read 200 may be divided into a seed 202, a left area 204, and a right area 206.

When the seed is selected, the mapping score calculating unit 104 sequentially maps the left area 204 and the right area 206 to the reference sequence in a direction opposite to the seed from the base connected to the seed 202, with respect to each of the left area 204 and the right area 206 based on the selected seed 202. Arrows in FIG. 3 show this operation. The left area 204 is sequentially mapped to the reference sequence in a left direction from a part A connected to the seed 202. The right area 206 is sequentially mapped to the reference sequence in a right direction from a part B connected to the seed 202. In this case, when the left area 204 and the right area 206 are mapped to the reference sequence, an aligning method (fully gapped alignment) in which insertion or deletion of the base is considered is used.

Specifically, the mapping score calculating unit 104 generates a first matrix in which the left area 204 of the read 200 and some of the reference sequence corresponding thereto are assigned to columns and rows, and a second matrix in which the right area 206 of the read 200 and some of the reference sequence corresponding to the right area 206 are assigned to columns and rows. Also, the mapping score calculating unit 104 assigns a match score or a mismatch score, which is set according to whether a row value and a column value of a corresponding cell match, to each cell of the generated first matrix and second matrix. In this case, the match score may be set to a real number of 0 or greater, and the mismatch score may be set to a real number less than 0. For example, the match score may be set to 1, and the mismatch score may be set to −1. However, this is only an example, and the match score and the mismatch score may be appropriately determined in consideration of a characteristic of a target sequence and the like.

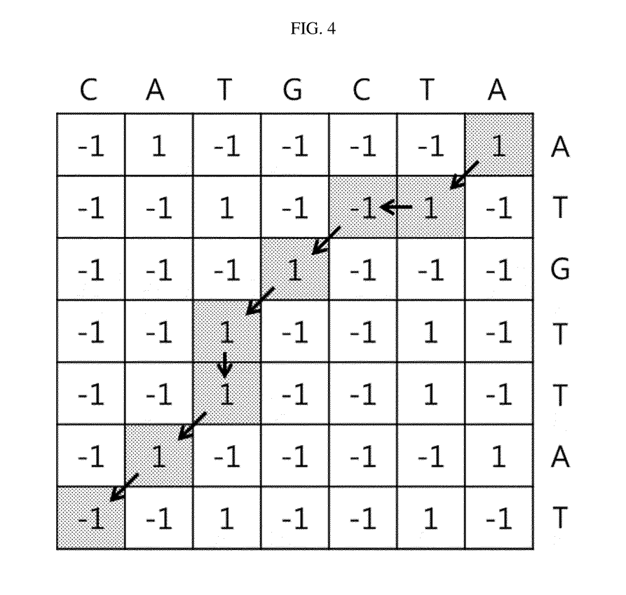

FIG. 4 is a diagram illustrating an exemplary operation of generating the first matrix and the second matrix. For example, it is assumed that the left area 204 of a specific read is arranged as the following x, and a reference sequence corresponding to the left area 204 is arranged as the following y.

x = “CATGCTA”
y = “TATTGTA”

In this case, when the first matrix in which y is assigned to rows and x is assigned to columns is formed, and the match score or the mismatch score is assigned to each cell of the generated first matrix according to whether a corresponding column and row match, the result is shown in FIG. 4. In this case, x forms each column while moving from the right to the left from the right most base. That is, the first column of the first matrix corresponds to the first base C of x, and the last column corresponds to the last base A of x. Also, y forms each row while moving from the top to the bottom from the right most base. That is, the first row of the first matrix corresponds to the last base A of y, and the last row corresponds to the first base T.

The embodiment illustrated in FIG. 4 shows an embodiment in which 1 is assigned as the match score and −1 is assigned as the mismatch score. Also, although not illustrated, the second matrix may also be generated through the same operation as in the first matrix.

When the first matrix and the second matrix are generated in this manner, next, the mapping score calculating unit 104 calculates the left mapping score and the right mapping score using the first matrix and the second matrix to which the match score or the mismatch score is assigned. That is, the left mapping score is calculated from the first matrix, and the right mapping score is calculated from the second matrix.

Specifically, as illustrated, the left mapping score is calculated as the greatest value of a sum of the match scores or the mismatch scores assigned along a path formed by starting from the top-rightmost cell ((1, n) of an m×n matrix) of the first matrix, sequentially moving in any direction of left, down, or diagonally downward to the left direction, and reaching the bottom-leftmost cell (m, 1) of the first matrix. As described above, the left mapping score is formed by sequentially mapping the left area 204 of the read 200 in a right to left direction. In the first matrix corresponding thereto, an optimal path is calculated while sequentially moving down to the left direction from the top-rightmost cell. Needless to say, when the method of forming rows or columns of the first matrix is changed, the path may be changed accordingly. For example, for convenience of calculation, it is assumed that the left area is reversed to form the first matrix, as follows.

x′ = “ATCGTAC”
y′ = “ATGTTAT”

In this case, unlike the above description, the left matrix is calculated while sequentially moving from the top-leftmost cell (1, 1) to the bottom-rightmost cell (m, n) of the first matrix. Also, even when rows and columns forming the first matrix are reversed, an optimal path calculating direction is changed accordingly.

Meanwhile, the right mapping score is calculated as the greatest value of a sum of the match scores or the mismatch scores assigned along a path formed by starting from the top-leftmost cell (1, 1) of the second matrix, sequentially moving in any direction of a right, bottom, or diagonally downward to the right direction, and reaching the bottom-rightmost cell (m, n) of the second matrix.

For example, among paths that can be formed while sequentially moving from cell (1,7) to (7,1) in the first matrix illustrated in FIG. 4, a path having the greatest sum of scores assigned to a corresponding path is denoted by the illustrated arrows. In this case, the mapping score, that is, the left mapping score, is as follows.

1+1−1+1+1+1+1−1=4

Also, the mapping score calculating unit 104 may also calculate the right mapping score from the second matrix using the same method.

When the left mapping score and the right mapping score are calculated in this manner, next, the read aligning unit 106 determines a mapping position in the reference sequence of the read using the calculated left mapping score and right mapping score. In an embodiment, among mapping positions having a sum of the left mapping scores and right mapping scores calculated for each mapping position in the reference sequence of the seed generated from the read that are greater than a set reference value, the read aligning unit 106 may determine a mapping position having the greatest sum as the mapping position of the read.

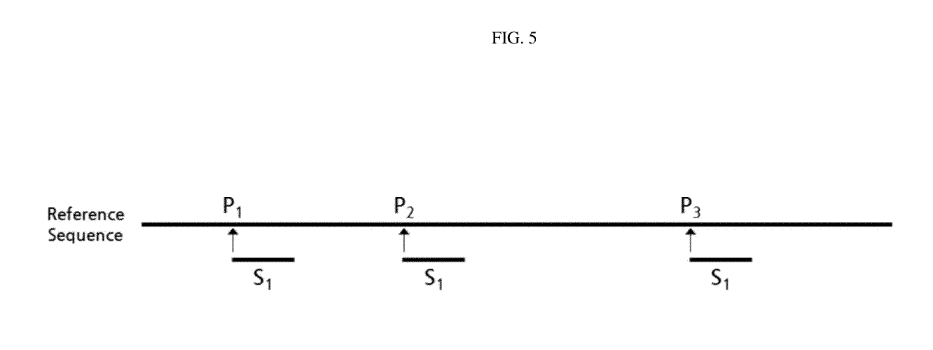

For example, as illustrated in FIG. 5, a seed S₁ extracted from the read exactly matches at three positions P₁, P₂, and P₃ of the reference sequence, and it is assumed that the left mapping score and the right mapping score of the read calculated at each mapping position are the same as shown in Table 1.

TABLE 1

| Mapping position | Left mapping score | Right mapping score | Sum |
|---|---|---|---|
| P₁ | 55 | 30 | 85 |
| P₂ | 50 | 40 | 90 |
| P₃ | 49 | 39 | 88 |

When it is assumed that the reference value is 70, since a sum of the mapping scores at each of the three mapping positions is equal to or greater than the reference value, the mapping positions may be mapping candidates. The read aligning unit 106 determines P₂ having the greatest sum 90 of the mapping scores among positions as the mapping position of the read.

Meanwhile, the sequence aligning apparatus 100 according to the embodiment of the present disclosure may further include an exact matching unit (not illustrated). Before the seed is extracted from the read derived from the sequencer, first, the exact matching unit attempts exact matching of the reference sequence. When the exact matching result shows that the read is exactly matched to the reference sequence, the exact matching unit determines that alignment of the read is successful. In other words, in embodiments of the present disclosure, the seed extracting unit 102 extracts the seed from only reads that are not exactly matched in the exact matching unit. In this manner, when the exact matching unit maps in advance the exact matching read to the reference sequence, since there is no need to perform a series of operations in which the seed is extracted from the read and the mapping score is calculated using the same, it is possible to increase an overall alignment speed.

Also, the sequence aligning apparatus 100 according to the embodiment of the present disclosure may further include an error number estimating unit (not illustrated) in addition to the exact matching unit. The error number estimating unit estimates the number of errors of the read derived from the sequencer, and when the estimated number of errors is equal to or greater than a predetermined reference value, discards a corresponding read. In the error number estimating unit, the read estimated to have the number of errors that is equal to or greater than a certain number is highly likely to fail in alignment, even when alignment with the reference sequence is actually attempted. Therefore, when the reads are excluded from sequence alignment in advance in this manner, it is possible to increase efficiency of sequence alignment.

Meanwhile, as an algorithm for estimating the number of errors that may occur in the derived read, any of several algorithms known in the related art may be used without limitation. Since descriptions thereof depart from the scope of the present disclosure, detailed descriptions thereof will not be provided herein.

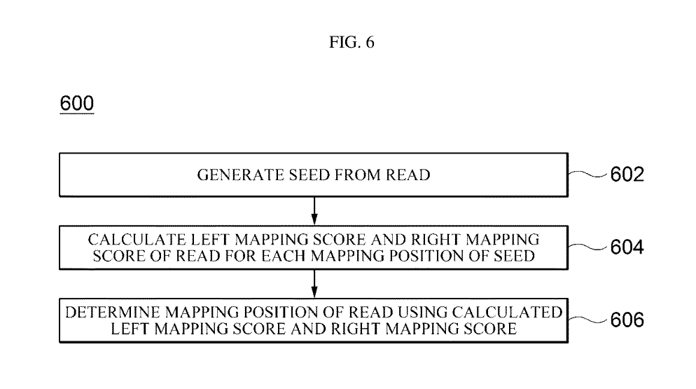

FIG. 6 is a flowchart illustrating a sequence aligning method 600 according to an embodiment of the present disclosure. The method illustrated in FIG. 6 may be performed by, for example, the above-described sequence aligning apparatus 100. While the flowchart illustrates that the method is performed in a plurality of operations, at least some operations may be performed in a different order, performed in combination with each other, omitted, or performed in sub-operations, or at least one operation that is not illustrated may be added and performed.

In operation 602, the seed extracting unit 102 extracts at least one seed that is exactly matched to the reference sequence from the read.

In operation 604, with respect to each of the at least one extracted seed, the mapping score calculating unit 104 maps a left area and a right area of the read to the reference sequence based on the seed at each mapping position of the reference sequence of each seed, and calculates a left mapping score and a right mapping score of each mapping position from the mapping result.

In operation 606, the read aligning unit 106 determines a mapping position in the reference sequence of the read using the calculated left mapping score and right mapping score.

According to embodiments of the present disclosure, when the read is aligned with the reference sequence, a 2D matrix between the read and the reference sequence is formed in order to increase accuracy. A sequence alignment algorithm (fully gapped alignment) in which both insertion and deletion of a chromosome are considered is applied using the matrix. Therefore, it is possible to increase accuracy of sequence alignment.

Also, according to embodiments of the present disclosure, in order to minimize degradation of a speed occurring when the fully gapped alignment is applied, the seed extracted from the read is exactly matched to the reference sequence. The fully gapped alignment is applied to only the exact matching area. Therefore, it is possible to compensate for the speed problem and increase accuracy of sequence alignment to near 100%.

Meanwhile, the embodiment of the present disclosure may include a computer readable recording medium including a program for executing the methods described in this specification in a computer. The medium may be specially designed and prepared for the present disclosure or a generally available medium in the field of computer software may be used. Examples of the computer readable recording medium include magnetic media such as a hard disk, a floppy disk, and a magnetic tape, optical media such as a CD-ROM and a DVD, magneto-optical media such as a floptical disk, and a hard device such as a ROM, a RAM, and a flash memory, that is specially made to store and perform the program instruction. Examples of the program instruction may include a machine code generated by a compiler and a high-level language code that can be executed in a computer using an interpreter.

While the present disclosure has been described above in detail with reference to representative embodiments, it may be understood by those skilled in the art that the embodiment may be variously modified without departing from the scope of the present disclosure. Therefore, the scope of the present disclosure is defined not by the described embodiment but by the appended claims, and encompasses equivalents that fall within the scope of the appended claims.

What is claimed is:

1. A sequence aligning apparatus, comprising:
a seed extracting unit configured to extract a seed that is matched to a reference sequence from a read;
a mapping score calculating unit configured to, with respect to the seed, map a first area to a left of the seed of the read and a second area to a right of the seed of the read, and calculate a left mapping score and a right mapping score based on the first and the second areas, respectively; and
a read aligning unit configured to determine a mapping position in the reference sequence of the read using the left mapping score and the right mapping score.

2. The apparatus of claim 1, wherein the mapping score calculating unit sequentially maps the first area of the read to the reference sequence in a left direction from a base connected to the seed at the first area of the read, and
sequentially maps the second area of the read to the reference sequence in a right direction from a base connected to the seed at the second area of the read.

3. The apparatus of claim 2, wherein the mapping score calculating unit generates a first matrix in which the left area of the read and a first part of the reference sequence corresponding to the first area are assigned to columns and rows, and a second matrix in which the second area of the read and a second part of the reference sequence corresponding to the second area are assigned to a second set of columns and rows, assigns a match score or a mismatch score, which is set according to whether a corresponding row value and a corresponding column value of a corresponding cell match, to each corresponding cell of the first matrix and the second matrix, and calculates the left mapping score and the right mapping score using the first matrix and the second matrix to which match scores and mismatch scores are assigned.

4. The apparatus of claim 3, wherein the left mapping score is a greatest value of a sum of the match scores and the mismatch scores assigned along a path formed by starting from a top-rightmost cell of the first matrix, sequentially moving in any direction of left, down, or diagonally downward to the left direction, and reaching a bottom-leftmost cell of the first matrix, and
the right mapping score is a greatest value of a sum of the match scores and the mismatch scores assigned along a path formed by starting from a top-leftmost cell of the second matrix, sequentially moving in any direction of a right, bottom, or diagonally downward to the right direction, and reaching a bottom-rightmost cell of the second matrix.

5. The apparatus of claim 3, wherein the match scores are real numbers of 0 or greater, and the mismatch scores are real numbers less than 0.

6. The apparatus of claim 5, wherein the match scores are set to 1, and the mismatch scores are set to −1.

7. The apparatus of claim 1, wherein the read aligning unit determines a mapping position having the greatest value of the sum as the mapping position of the read, among mapping positions having sums of the left mapping scores and the sums of the right mapping scores calculated for the mapping position in the reference sequence of the seed that is greater than a set reference value.

8. A sequence aligning method, comprising:
extracting, by a seed extracting unit, a seed that is matched to a reference sequence from a read;
mapping, by a mapping score calculating unit, with respect to the seed, a first area to a left of the seed of the read and a second area to a right of the seed of the read, and calculating a left mapping score and a right mapping score based on the first and the second areas, respectively; and
determining, by a read aligning unit, a mapping position in the reference sequence of the read using the left mapping score and the right mapping score.

9. The method of claim 8, wherein, the calculating of the left mapping score and the right mapping score comprises:
sequentially mapping the first area to the reference sequence in a left direction from a base connected to the seed at the first area of the read, and
sequentially mapping the second area to the reference sequence in a right direction from a base connected to the seed at the second area of the read.

10. The method of claim 9, wherein the calculating of the left mapping score and the right mapping score further comprises:
generating a first matrix in which the first area of the read and a first part of the reference sequence corresponding to the first area are assigned to a first set of columns and rows, and a second matrix in which the second area of the read and a second part of the reference sequence corresponding to the second area are assigned to a second set of columns and rows,
assigning a match score or a mismatch score, which is set according to whether corresponding a row value and a corresponding column value of a corresponding cell match, to each corresponding cell of the first matrix and the second matrix, and
calculating the left mapping score and the right mapping score using the first matrix and the second matrix to which match scores and the mismatch scores are assigned.

11. The method of claim 10, wherein the left mapping score is a greatest value of a sum of the match scores and the mismatch scores assigned along a path formed by starting from a top-rightmost cell of the first matrix, sequentially moving in any direction of left, down, or diagonally downward to the left direction, and reaching a bottom-leftmost cell of the first matrix, and
the right mapping score is a greatest value of a sum of the match scores and the mismatch scores assigned along a path formed by starting from the top-leftmost cell of the second matrix, sequentially moving in any direction of a right, bottom, or diagonally downward to the right direction, and reaching the bottom-rightmost cell of the second matrix.

12. The method of claim 10, wherein the match scores are real numbers of 0 or greater, and the mismatch scores are real numbers less than 0.

13. The method of claim 12, wherein the match scores are set to 1, and the mismatch scores are set to −1.

14. The method of claim 8, wherein the determining of the mapping position comprises:
determining a mapping position having the greatest value of the sum as the mapping position of the read, among mapping positions having sums of the left mapping scores and the sums of the right mapping scores calculated for the mapping position in the reference sequence of the seed that is greater than a set reference value.
